(19) United States
(12) Patent Application Publication
(10) Pub. No.: US 2012/0169823 A1
(43) Pub. Date: Jul. 5, 2012

(54) Printhead Fabrication Methods, Printhead Substrate Assembly Fabrication Methods, And Printheads

(76) Inventors: Napoleon J. Leoni, San Jose, CA (US); Omer Gila, Cupertino, CA (US)

(21) Appl. No.: 13/382,832

(22) PCT Filed: Jul. 8, 2009
(86) PCT No.: PCT/US2009/049948

§ 371 Date: Jan. 6, 2012

(51) Int. Cl. B41J 2/415; B41J 2/16

(52) U.S. Cl. 347/141; 29/890.1

(57) ABSTRACT

Printhead fabrication methods, printhead substrate assembly 32 fabrication methods, and printheads are described. According to one aspect, a printhead fabrication method includes providing a substantially planar upper surface 34 of a substrate assembly 32 which comprises circuitry 13, wherein the providing comprises, using a fill material 26, filling a plurality of valleys 15 of the substrate assembly 32 which are defined by a plurality of circuitry protrusions 14 of the circuitry 13. The method may also include, after the providing the substantially planar upper surface 34 of the substrate assembly 32, providing a plurality of printhead structures 50 over the substantially planar upper surface 34 of the substrate assembly 32 to form a printhead.

### BACKGROUND

Imaging devices capable of printing images upon paper and other media are ubiquitous and used in many applications including monochrome and color applications. The use and popularity of these devices continues to increase as consumers at the office and home have increased their reliance upon electronic and digital devices, such as computers, digital cameras, telecommunications equipment, etc.

A variety of methods of forming hard images upon media exist and are used in various applications and environments, such as home, the workplace and commercial printing establishments. Some examples of devices capable of providing different types of printing include laser printers, impact printers, inkjet printers, commercial digital presses, etc.

Throughput and cost per page are important attributes in some applications, for example, in some high-quality digital commercial press applications. Some configurations utilize an electrophotographic engine with laser based imaging and a photoconductor imaging plate. However, the scanning assemblies and photoconductor materials of some arrangements are limitations to increased operating speeds and imaging widths of the devices which may limit throughput.

At least some aspects of the disclosure are directed towards imaging apparatus and methods of fabricating imaging apparatuses which avoid some of the above-mentioned limitations.

### DESCRIPTION OF DRAWINGS

FIGS. 1A-1F are cross-sectional views of different acts of forming a substrate assembly of a printhead according to one embodiment of the disclosure.

FIG. 2 is a cross-sectional view of a portion of a printhead according to one embodiment of the disclosure.

FIG. 3 is a cross-sectional view of a portion of a printhead having defects in the form of air gaps.

FIG. 4 is a flow chart of a method of fabricating a printhead according to one embodiment.

### DETAILED DESCRIPTION

The present disclosure describes printheads and methods of fabricating printheads and printhead substrate assemblies according to some embodiments. The printheads include a plurality of printhead structures in at least one embodiment. In a more specific example, a charge emitting printhead is disclosed which includes a plurality of printhead structures in the form of nozzles which are configured to eject electrons to form latent images upon a suitable imaging member for subsequent development during imaging operations of the printhead. Additional details regarding the example charge emitting printheads are described in U.S. Pat. Nos. 4,155,093 and 4,160,257 and U.S. Patent Application Nos. 200603024 and 200700440. These printheads form latent images without use of a scanning assembly in one example. Aspects of the present disclosure may also be applicable to other types of printheads and the fabrication of such printheads.

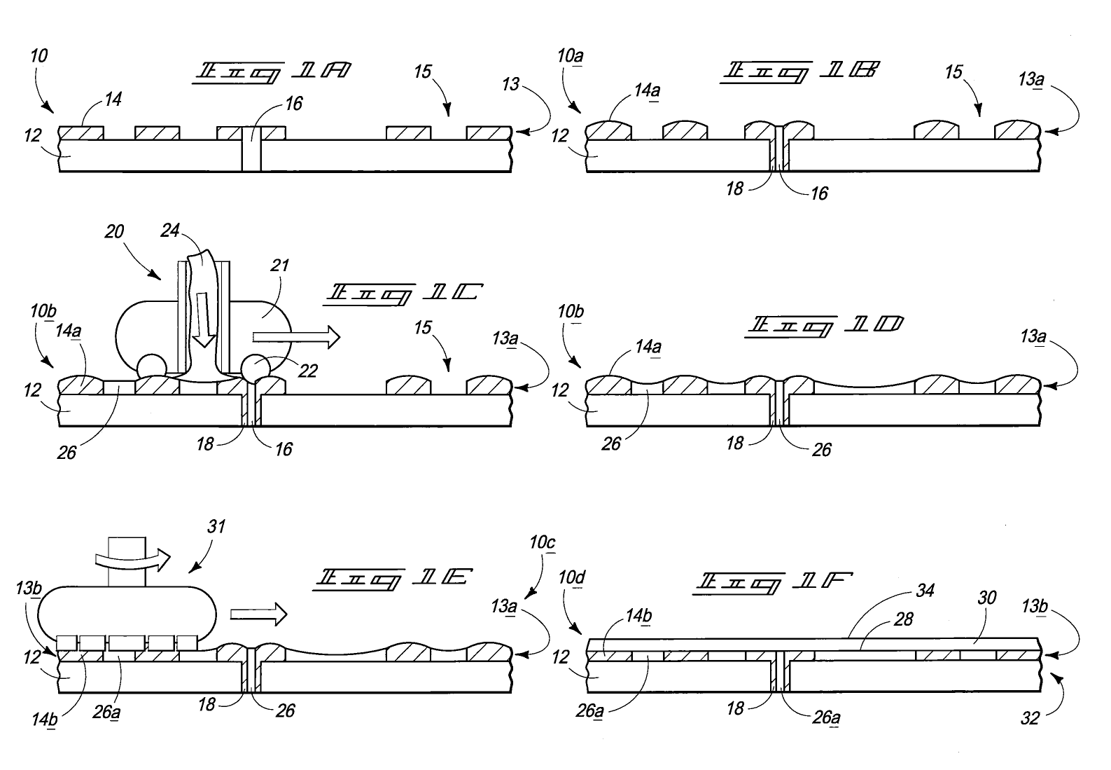

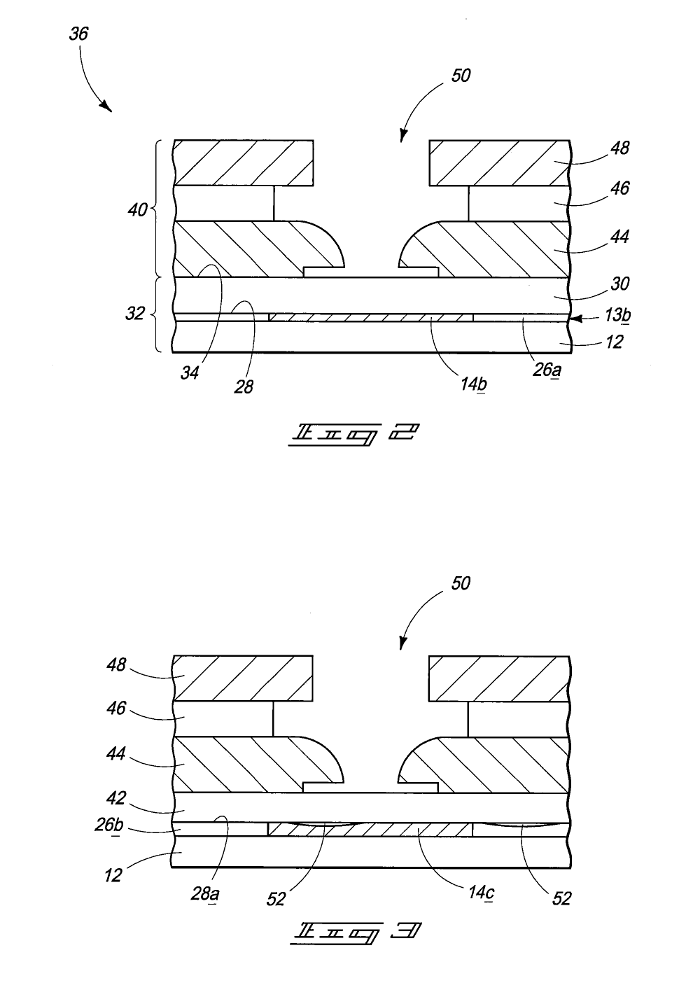

Referring to FIGS. 1A-1F, a plurality of processing acts for fabricating a substrate assembly of a printhead are shown. FIGS. 1A-1F illustrate a fragment 10-10d of the substrate assembly at a plurality of intermediate processing acts. More, less or alternative acts may be used in addition to or in place of the acts shown in FIGS. 1A-1F in other embodiments.

Referring to FIG. 1A, the fragment 10 includes a substrate 12, such as a FR4 board or a glass epoxy substrate in illustrative examples. In one embodiment, the substrate 12 is relatively thin (e.g., 250 microns) and may be conformable to a flat rigid carrier substrate (e.g., an aluminum plate serving structural and thermal purposes in one arrangement) during processing (the carrier substrate is not shown in FIGS. 1A-1F).

In one embodiment, circuitry 13 is formed upon an upper surface of substrate 12. The fragment 10 also includes a via 16 within substrate 12 in the depicted embodiment. In the described example embodiment of fabricating a printhead, circuitry 13 may be referred to as printhead circuitry as described in additional detail below. Circuitry 13 includes a plurality of circuitry protrusions 14 which extend upwardly from an upper surface of substrate 12. In the described example embodiment, circuitry protrusions 14 are conductive traces formed upon the surface of substrate 12 by deposition and etching of a suitable conductor (e.g., copper).

Circuitry protrusions 14 define a plurality of valleys 15 above the upper surface of substrate 12 and result in the fragment 10 having an uneven upper surface topography as shown. For example, the circuitry protrusions 14 may have heights between 20-100 microns in some arrangements (e.g., protrusions 14 formed using ½ oz copper traces may have heights of approximately 17.5 microns which may become larger if plating of vias 16 is also implemented). Furthermore, in some embodiments, the valleys 15 may have relatively large widths (e.g., 0.2 to 10 s of mm).

Referring to FIG. 1B, the fragment 10a has undergone processing to form a via conductor 18 within via 16. In one embodiment, a plating process of a suitable conductor (e.g., copper) is performed to form the via conductor 18. In some arrangements, some of the conductive material may also be deposited upon circuitry protrusions 14 which may further increase the height of the circuitry protrusions 14a of circuitry 13a and further increase the non-uniformity of the surface topography of the fragment 10a.

Referring to FIG. 1C, a fill material 24 is provided within the valleys 15 intermediate the circuitry protrusions 14 over the surface of the substrate 12 of fragment 10b to form a plurality of fill structures 26. In one example, the fill material 24 is a dielectric material to provide suitable electrical insulation of the circuitry protrusions 14. In more specific examples, the fill material 24 may be a flowable dielectric epoxy resin paste such as PHP-900 available from San-ei Kagaku Co., Ltd. or PP2795 available from Lackwerke Peters GmbH.

In the example shown in FIG. 1C, a squeegee 20 is utilized to provide the fill material 24 to the substrate 12 to form the fill structures 26. The fill material 24 may be dispensed under pressure through a conduit within a head 21 of the squeegee 20 to the upper surface of the substrate 12. In one embodiment, the squeegee 20 may be moved across the upper surface of the substrate 12 to dispense the fill material 24 into the different valleys 15. A seal 22, such as an o-ring, conforms to variances in the surface topology caused by the circuitry protrusions 14a and operates to direct the flowable fill material 24 to substantially completely fill the valleys 15 as well as via 16 in one embodiment. The fill material 24 is conformal to the surface of the substrate 12 and the circuitry protrusions 14a in one embodiment. After dispensing, the fill material 24 may be cured (e.g., thermally) to provide solid fill structures 26. In one embodiment, dispensing pressures may be 80-400 kPa and curing may be implemented in an oven or through UV radiation. The valleys 15 may be filled using different methods and apparatus in other embodiments.

Referring to FIG. 1D, the squeegee 20 has processed the entirety of the upper surface of the fragment 10b. As shown in FIG. 1D, the valleys 15 of FIG. 1B have been individually substantially completely filled by the fill material 24. In some arrangements (e.g., assemblies having relatively large valleys 15), the squeegee 20 may make a plurality of passes to completely fill the valleys 15. In some implementations, different seals 22 having progressively increasing durometer ratings may be used in different passes of the squeegee 20.

Referring to FIG. 1E, polishing of fragment 10c is shown. In one polishing example, a rotating polishing head 31 is moved across the upper surface of the substrate 12 which includes the circuitry 13a. The polishing operates to remove conductive material of the circuitry protrusions 14a providing circuitry protrusions 14b having substantially planar upper surfaces. The polishing also operates to remove fill material 24 from the fragment 10c. For example, the fill material 24 may be removed from structures 26 (providing structures 26a) as well as the upper surfaces of circuitry protrusions 14a.

Referring to FIG. 1F, the fragment 10d is shown after the processing of FIG. 1E. In the depicted example, fragment 10d has a substantially planar upper surface 28. In the depicted example, the upper surfaces of circuitry 13b including circuitry protrusions 14b and upper surfaces of the fill structures 26a are substantially co-planar and define the upper surface 28. In the depicted example embodiment, the upper surfaces of the circuitry protrusions 14b and fill structures 26a are outwardly exposed after the polishing. In one example, the substantially planar surface topography includes peaks and valleys which vary less than 1-2 microns.

In one embodiment where a printhead is being formed, the assembly of FIG. 1F may undergo further processing following the polishing to provide a support layer 30 over surface 28. In one embodiment, the support layer 30 may comprise a liquid dielectric material, such as R21-2615 silicone rubber available from NuSil Technology mixed with a TiO₂ composition having designation MED3-4102 and which is also available from NuSil Technology. In one embodiment, MED3-4102 provides TiO₂ (75% by weight) in a silicone oil which is mixed with the silicone rubber so that the final mixture has a 40% TiO₂ concentration by volume. In one example, the mixture is diluted at a ratio of 1:30 into a solvent (e.g., Xylene) to provide a relatively low viscosity coating. The material may be applied over circuitry 13b by a roller or blade coater to provide a layer having an initial thickness of approximately 40 microns and which is approximately 20-25 microns after evaporation of the solvent and with uniformity of better than 1 micron in one embodiment. Support layer 30 may have a thickness of 10-50 microns in example embodiments.

In one embodiment, the substrate 12, the circuitry 13b, fill structures 26a, and the support layer 30 may be referred to as a substrate assembly 32. The substrate assembly 32 includes a substantially planar surface 34 defined by the upper surface of layer 30 in one embodiment. In one arrangement, the substrate assembly 32 is solid and void-free. In another embodiment, the substrate assembly 32 includes substrate 12, circuitry 13b and fill structures 26a.

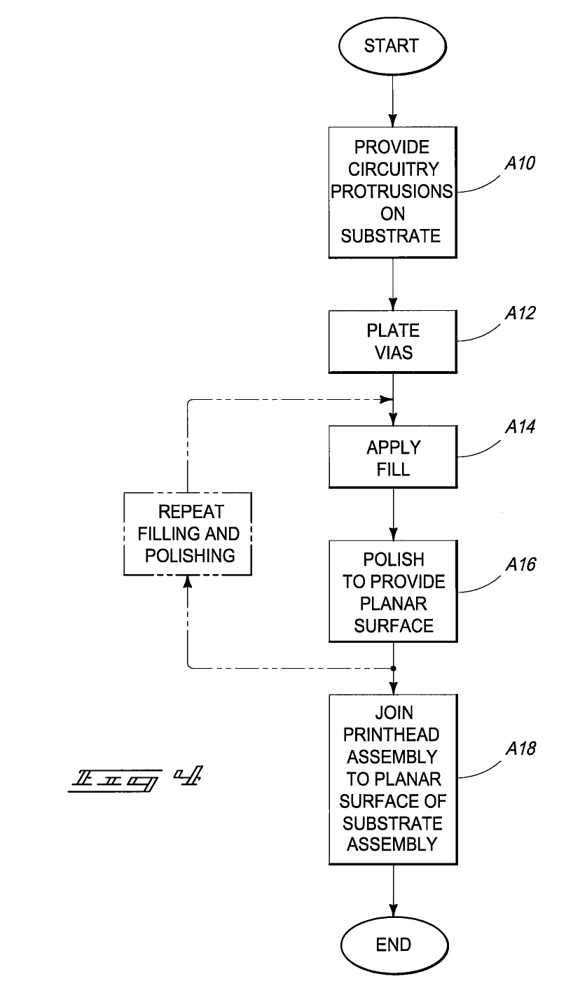

Referring to FIG. 2, a fragment 36 of a portion of one embodiment of a printhead is shown. The depicted fragment 36 includes a printhead structure 50 in the form of a nozzle in the described example embodiment where the printhead comprises a charge emitting printhead. The nozzle is configured to emit a plurality of electrons to form latent images upon an imaging member (e.g., belt or drum) which may be subsequently developed. A complete printhead typically comprises a plurality of printhead structures 50, such as nozzles, to selectively eject electrons to discharge respective portions of a blanket charge formed upon the imaging member to form the latent images upon the imaging member in one embodiment.

In the illustrated embodiment, the printhead includes substrate assembly 32 coupled with a printhead assembly 40. In one embodiment where the printhead comprises a charge emitting printhead, the printhead assembly 40 includes a bottom or discharge electrode 44, spacer layer 46, and a top or screen electrode 48 for individual ones of the printhead structures 50 in the form of nozzles.

In one embodiment, printhead assembly 40 may be processed separately from substrate assembly 32. Additional details regarding fabrication of a printhead assembly 40 according to some arrangements are described in “Printhead Fabrication Methods And Printheads”, listing Napoleon Leoni, Omer Gila, Cary G. Addington, Paul H. McClelland, and Henryk Birecki as inventors, having attorney docket no. PDNO. 200902479, and filed the same day as the present application.

Following completion of the processing of printhead assembly 40 and the fabrication of the substrate assembly 32 including a substantially planar surface 34, the substrate assembly 32 and printhead assembly 40 may be coupled and bonded with one another in one embodiment.

In one embodiment, this bonding procedure is in the form of a thermal lamination under a vacuum in which a plurality of bottom electrodes 44 adhere to a partially cured support layer 30. In one more specific embodiment, the support layer 30 of the substrate assembly 32 is partially cured at approximately 105 degrees C. for 18 hours. Thereafter, the thermal lamination under vacuum processing may be implemented using pressures of approximately 20-40 kPa at 130 degrees C. for approximately 10-20 minutes followed by lamination processing at temperatures of 140 degrees C. for approximately 4 minutes in one embodiment.

Different methods of fabricating a printhead are possible. In another embodiment, the substrate assembly 32 may be formed and layers of the printhead assembly 40 may be subsequently formed upon the substrate assembly 32. In this illustrative example, the bottom electrodes 44 may be attached to the support layer 30 after the partially cured processing of the support layer 30 described above using a room temperature pressure lamination (e.g., approximately 400-600 kPa for approximately 5-20 seconds in one example).

As mentioned above, the substrate assembly 32 may be void-free in some embodiments which may reduce or eliminate the presence of air breakdowns in relatively high voltage applications as described further below.

As also mentioned above, some of the circuitry protrusions 14b may comprise circuitry configured to interact with printhead structures 50 to implement imaging operations of the printhead. Accordingly, in one embodiment, at least some of the circuitry protrusions 14b of the substrate assembly 32 may be aligned with the printhead structures 50 of the printhead assembly 40 prior to bonding of the assemblies 32, 40. For example, the circuitry protrusion 14b of FIG. 2 may comprise an RF electrode which is aligned with the printhead structure 50 in one embodiment. In one embodiment, appropriate biasing and control signals may be provided to the discharge and screen electrodes 44, 48 and the RF electrode to cause the emission of electrons from the printhead structure 50. In one more specific example, an RF frequency high voltage (e.g., 3 kVₚₖ₋ₚₖ at 10 MHz) is applied between the RF electrode and the discharge electrode 44 to provide a micro-plasma in the nozzle of the printhead structure 50 and resulting in the emission of electrons from the nozzle.

Referring to FIG. 3, an example of a structure having unwanted air gaps 52 is shown. More specifically, air gaps 52 may result from non-uniformities in the upper surface 28a which are greater than any non-uniformities occurring in the substantially planar upper surface 28 described above (e.g., less than 1-2 microns). The existence of the air gaps 52 between fill structures 26b and protrusions 14c and the support layer 42 may result in the generation of unwanted air breakdown in the air gaps 52 which may cause localized heating and failure of support layer 42.

Referring to FIG. 4, a method of forming a printhead is shown according to one embodiment. Other methods are possible including more, less or alternative acts or acts arranged according to different orders.

At an Act A10, a plurality of circuitry protrusions are provided upon a substrate. In one example, the circuitry protrusions are formed upon an underlying substrate which may include one or more vias.

At an Act A12, the one or more vias are plated. Act A12 may be omitted if no vias are present in the substrate.

At an Act A14, fill material is applied to fill valleys between circuitry protrusions. In one example embodiment, a squeegee is moved across the surface of the substrate which includes the circuitry protrusions and the squeegee dispenses the fill material.

At an Act A16, the surface of the substrate is polished to provide a substantially planar upper surface. In one embodiment, the polishing removes conductive material of the circuitry protrusions as well as fill material. Following the polishing, a support layer may be formed and which also includes a substantially planar outer surface.

Acts A14 and/or A16 may be repeated to achieve a sufficiently planar surface in one embodiment (e.g., uniformity of better than 1 micron in one embodiment).

At an Act A18, a printhead assembly may be joined with the substrate assembly to form a printhead. In one embodiment, circuit features of the substrate assembly may be aligned with printhead structures of the printhead assembly to form an operable printhead. In other embodiments, the printhead structures may be formed upon the substrate assembly.

Some example embodiments of the disclosure are described with respect to printheads. The example described methods may be applied to other applications where it may be desired to have a structure with a flat surface and with conductive traces embedded into a dielectric with negligible topography. For example, aspects of the disclosure may be used to fabricate other types of devices, such as capacitive sensors, high voltage devices where air gaps create unwanted breakdowns, and large area sensor arrays.

At least some aspects of the disclosure provide advantages compared with other conventional arrangements. In one example, other methods may use flat rigid substrates, such as glass or ceramic, and sputtered or evaporated electrodes are formed to attempt to maintain a near flat topography. More specifically, a flat piece of glass or ceramic may be polished, and then a sub-micron layer of a conductor could be deposited (e.g., sputtered) through a near contact mask. Such a method is relatively slow, expensive, precludes use of vias, and is generally not suitable for large scale production compared with aspects of the present disclosure.

The protection sought is not to be limited to the disclosed embodiments, which are given by way of example only, but instead is to be limited only by the scope of the appended claims.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A printhead fabrication method comprising:
providing a substantially planar upper surface 34 of a substrate assembly 32 which comprises circuitry 13, wherein the providing comprises, using a fill material 26, filling a plurality of valleys 15 of the substrate assembly 32 which are defined by a plurality of circuitry protrusions 14 of the circuitry 13; and
after the providing the substantially planar upper surface 34 of the substrate assembly 32, providing a plurality of printhead structures 50 over the substantially planar upper surface 34 of the substrate assembly 32 to form a printhead.

2. The method of claim 1 further comprising forming the circuitry protrusions 14 comprising circuit traces.

3. The method of claim 1 or 2 wherein the providing the printhead structures 50 comprises providing the printhead structures 50 comprising a plurality of nozzles which are configured to emit electrons to form latent images during imaging operations of the printhead.

4. The method of claim 3 further comprising forming at least some of the circuitry protrusions 14 to cause the emission of the electrons from respective ones of the nozzles.

5. The method of claim 1, 2, 3 or 4 further comprising aligning at least some of the circuitry protrusions 14 of the substrate assembly 32 with the printhead structures 50.

6. The method of claim 1, 2, 3, 4 or 5 wherein the filling comprises dispensing the fill material 26 via a squeegee 20.

7. The method of claim 1, 2, 3, 4, 5, or 6 wherein the providing the substantially planar upper surface 34 comprises polishing the upper surface after the filling and before the providing the printhead structures 50.

8. The method of claim 1, 2, 3, 4, 5, 6 or 7 further comprising, before the providing the printhead structures 50, providing a support layer 30 over the circuitry protrusions 14 and the fill material 26 and which comprises the substantially planar upper surface 34 of the substrate assembly 32.

9. The method of claim 8 wherein the providing the support layer 30 comprises depositing and at least partially curing a liquid dielectric material which comprises the substantially planar upper surface 34 of the substrate assembly 32.

10. A printhead substrate assembly 32 fabrication method comprising:
providing printhead circuitry 13 adjacent to a first surface of a substrate 12, wherein the printhead circuitry 13 is configured to interact with a plurality of printhead structures 50 of a printhead assembly 40 during imaging operations using a printhead comprising the substrate assembly 32 and the printhead assembly 40;
providing fill material 26 adjacent to the first surface of the substrate 12; and
using the fill material 26, providing a substantially planar outer surface 34 on a side of the substrate assembly 32 which is adjacent to the first surface of the substrate 12.

11. The method of claim 10 wherein the providing the fill material 26 comprises dispensing the fill material 26 via a squeegee 20 moving adjacent to the first surface of the substrate 12.

12. The method of claim 10 or 11 wherein the providing the substantially planar outer surface 34 comprises polishing the outer surface on the side of the substrate assembly 32 after the flowing.

13. A printhead comprising:
a substrate assembly 32 comprising:
a substrate 12;
circuitry protrusions 14 over an upper surface of the substrate 12; and
fill material 26 over the upper surface of the substrate 12 to provide a substantially planar upper surface 34 of the substrate assembly 32; and
a printhead assembly 40 coupled with the substrate assembly 32 and which comprises a plurality of printhead structures 50.

14. The printhead of claim 13 wherein at least some of the circuitry protrusions 14 of the substrate assembly 32 are aligned with the printhead structures 50.

15. The printhead of claim 13 or 14 wherein the fill material 26 is conformal to the upper surface of the substrate 12 and the circuitry protrusions 14 of the substrate assembly 32.
